(19) United States
(12) Patent Application Publication
(10) Pub. No.: US 2010/0157356 A1
(43) Pub. Date: Jun. 24, 2010

(54) System and Method for Inserting Advertisements

(76) Inventors: John Edgar Salsman, III, Lexington, KY (US); Timothy S. Seevers, Lexington, KY (US); Joel Stinson Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/342,406

(22) Filed: Dec. 23, 2008

(51) Int. Cl. G06F 3/12

(52) U.S. Cl. 358/1.15

(57) ABSTRACT

A method, computer program product, and print driver for receiving an indication, on a computing device, of content to be printed on a printing device. A portion of a printable area of the printing device is partitioned into at least two printable areas. A first of the printable areas is configured for including at least a portion of the content, and a second of the printable areas is configured for including one or more advertisements; thus defining a modified print job.

### TECHNICAL FIELD

This disclosure relates to printing systems and, more particularly, to printing systems that insert advertisements into printed documents.

### BACKGROUND

Advertisements have been used to offset operational costs for various services and products. For example, non-cable television channels use commercials to offset the cost of producing and broadcasting various television shows. Print publications (e.g. magazines and newspapers) utilize advertisements to reduce the cost of these printed publications.

With the Internet age has come a plethora of new technologies, services, and business models. Not the least of which is the Internet-advertising model, where virtually all revenue is generated by advertisements. For example, Google, Inc. has led the way in the Internet-advertising model by not only providing advertisements alongside of their search results but by tuning the advertisements to be relevant to the search results and, ultimately, to the consumer that did the search.

### SUMMARY OF DISCLOSURE

In an implementation, a method includes receiving an indication, on a computing device, of content to be printed on a printing device. A portion of a printable area of the printing device is partitioned into at least two printable areas. A first of the printable areas is configured for including at least a portion of the content, and a second of the printable areas is configured for including one or more advertisements; thus defining a modified print job.

One or more of the following features may be included. The modified print job may be provided to the printing device. The one or more advertisements may be obtained from a remote source. Obtaining the one or more advertisements from a remote source may include obtaining, on the computing device, the one or more advertisements from the remote source. Obtaining the one or more advertisements from a remote source may include obtaining, on the printing device, the one or more advertisements from the remote source.

The remote source may be a remote advertisement server. The second of the printable areas being configured for including one or more advertisements may include an essentially rectangular area positioned proximate one of the edges of a printable page producible by the printing device.

In another implementation, a computer program product resides on a computer readable medium that has a plurality of instructions stored on it. When executed by a processor, the instructions cause the processor to perform operations including receiving an indication, on a computing device, of content to be printed on a printing device. A portion of a printable area of the printing device is partitioned into at least two printable areas. A first of the printable areas is configured for including at least a portion of the content, and a second of the printable areas is configured for including one or more advertisements; thus defining a modified print job.

One or more of the following features may be included. The modified print job may be provided to the printing device. The one or more advertisements may be obtained from a remote source. Obtaining the one or more advertisements from a remote source may include obtaining, on the computing device, the one or more advertisements from the remote source. Obtaining the one or more advertisements from a remote source may include obtaining, on the printing device, the one or more advertisements from the remote source.

The remote source may be a remote advertisement server. The second of the printable areas being configured for including one or more advertisements may include an essentially rectangular area positioned proximate one of the edges of a printable page producible by the printing device.

In another implementation, a print driver is configured to perform operations including receiving an indication, on a computing device, of content to be printed on a printing device. A portion of a printable area of the printing device is partitioned into at least two printable areas. A first of the printable areas is configured for including at least a portion of the content, and a second of the printable areas is configured for including one or more advertisements; thus defining a modified print job.

One or more of the following features may be included. The modified print job may be provided to the printing device. The one or more advertisements may be obtained from a remote source. Obtaining the one or more advertisements from a remote source may include obtaining, on the computing device, the one or more advertisements from the remote source. Obtaining the one or more advertisements from a remote source may include obtaining, on the printing device, the one or more advertisements from the remote source.

The remote source may be a remote advertisement server. The second of the printable areas being configured for including one or more advertisements may include an essentially rectangular area positioned proximate one of the edges of a printable page producible by the printing device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printer advertisement process executed by a computing device coupled to a distributed computing network;

FIG. 2 is a flowchart of the printer advertisement process of FIG. 1; and

FIG. 3 is a diagrammatic view of the printable areas of a print job and a modified print job.

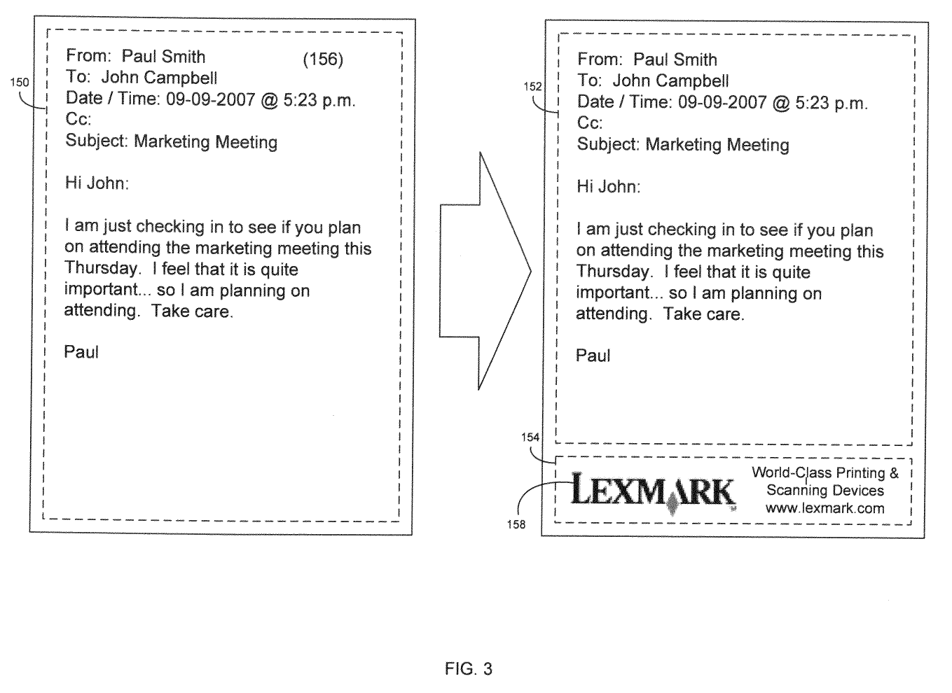

Like reference symbols in the various drawings indicate like elements.

### DETAILED DESCRIPTION OF THE PREFERRED EMBODIMENTS

### System Overview:

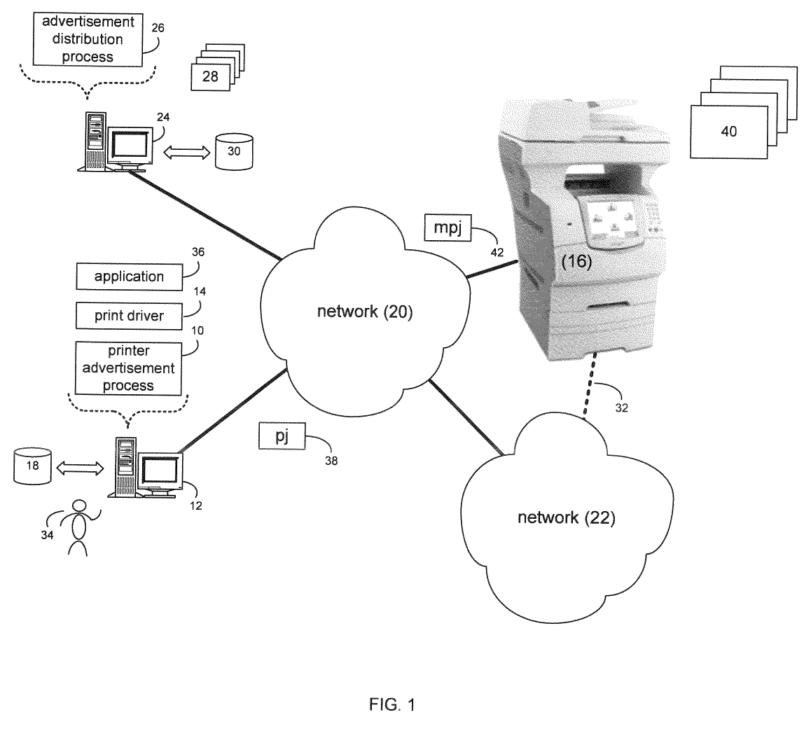

Referring to FIG. 1, there is shown a printer advertisement process 10 that may reside on and may be executed by a computing device (e.g., computing device 12). Printer advertisement process 10 may be a stand alone application or may be incorporated into another application, such as print driver 14. As will be discussed below in greater detail, printer advertisement process 10 may receive an indication, on e.g., computing device 12, of content to be printed on a printing device (e.g., printing device 16). Printer advertisement process 10 may partition a portion of a printable area of printing device 16 into at least two printable areas, a first portion for content and a second for one or more advertisements. By including advertisements within the documents printed by printing device 16, the cost of ownership of printing device 16 may be reduced. For example, the cost of purchasing printing device 16 may be reduced and/or the cost of consumables for printing device 16 may be reduced.

The instruction sets and subroutines of printer advertisement process 10, which may be stored on storage device 18 coupled to computing device 12, may be executed by one or more processors and one or more memory architectures incorporated into computing device 12. Storage device 18 may be an internal storage device included within computing device 12. Examples of storage device 18 may include but are not limited to: a hard disk drive; a tape drive; an optical drive; a RAID array; a random access memory; a read-only memory; a compact flash (CF) storage device, a secure digital (SD) storage device, and a memory stick storage device. Computing device 12 may execute an operating system, examples of which may include but are not limited to a Windows™ based operating system, a Mac™ based operating system, a Unix™ based operating system and a Linux™ based operating system.

Computing device 12 and/or printing device 16 may be coupled to network 20 (e.g., the Internet or a local area network). Examples of computing device 12 may include but are not limited to a desktop computer, a laptop computer, a notebook computer, a personal digital assistant, or a data enabled cellular telephone. Examples of printing device 16 may include but are not limited to an inkjet printing system, a laser printing system, and a multifunction printing system. Examples of such a multifunction printing system may include but are not limited to a Lexmark X850e and a Lexmark X646e, both of which are available from Lexmark International of Lexington, Ky.

Network 20 may be coupled to one or more secondary networks (e.g., network 22), examples of which may include but are not limited to: a local area network; a wide area network; or an intranet, for example.

Server computer 24 may be an advertisement server and may execute advertisement distribution process 26 that distributes advertisements 28 to e.g., devices executing printer advertisement process 10 (e.g. computing device 12). Examples of server computer 24 may include but are not limited to a personal computer, a server computer, a series of server computers, a mini computer, and a mainframe computer. The instruction sets and subroutines of advertisement distribution process 26, which may be stored on storage device 30 coupled to server computer 24 may be executed by one or more processors (not shown) and one or more memory architectures (not shown) incorporated into server computer 24. Server computer 24 may be a web server (or a series of servers) running a network operating system, examples of which may include but are not limited to: Microsoft Windows XP Server™; Novell Netware™; or Redhat Linux™, for example.

Computing device 12 may communicate with server computer 24 and/or printing device 16 via network 20 and/or network 22. Further, printing device 16 may be coupled to network 20 through secondary network 22, as illustrated with phantom link line 32.

### Printer Advertisement Process:

As discussed above, printer advertisement process 10 may receive an indication, on e.g., computing device 12, of content to be printed on a printing device (e.g., printing device 16). Printer advertisement process 10 may partition a portion of a printable area of printing device 16 into at least two printable areas, a first portion for content and a second portion for one or more advertisements.

While using computing device 12, user 34 may execute one or more applications 36 on computing device 12. An example of application 36 may include but is not limited to a word processing application, a spreadsheet application, a photo editing application, a graphics application, or an e-mail application. While using application 36, user 34 may wish to execute one or more print functions. Examples of a print function may include but are not limited to a screen print function, a document print function, and image print function, or a photo print function.

Typically, when initiating a print function, print driver 14 may be utilized to convert the data being manipulated by applications 36 into a format that is recognizable/usable by printing device 16. Once print driver 14 makes such a data conversion, the appropriate data signals (i.e. print job 38) may be transmitted to printing device 16 via network 20 and/or network 22. Upon receiving print job 38, printing device 16 may process print job 38 and may produce one or more printed pages 40.

While computing device 12 is shown to be coupled to printing device 16 via network 20 and/or network 22, this is for illustrative purposes only and is not intended to be a limitation of this disclosure, as other configurations are possible. For example, computing device 12 may be directly coupled to printing device 16 via a universal serial bus (i.e. USB) cable or a standard printer cable.

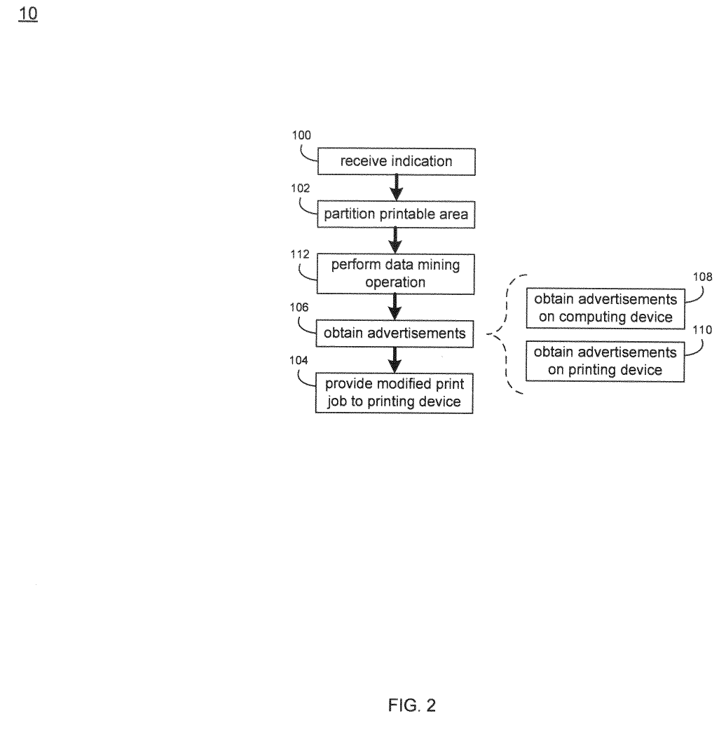

Referring also to FIGS. 2 & 3, when user 34 initiates the above-described print function, printer advertisement process 10 may receive 100 an indication (on computing device 12) that such a print function was initiated and, therefore, content is going to be printed on printing device 16. For example, printer advertisement process 10 may monitor print driver 14 to determine whenever an application (e.g. application 36) calls print driver 14 and initiates such a print function. As discussed above, printer advertisement process 10 may be a stand alone application or may be incorporated into print driver 14.

In response to such an indication, printer advertisement process 10 may partition 102 all or a portion of the printable area (e.g. printable area 150) of printing, device 16 into at least two printable areas (e.g. printable area 152, 154). For example, assume that application 36 is an e-mail client application and user 34 is utilizing application 36 to review and compose e-mail. Assume that user 34 receives e-mail 156 from sender “Paul Smith”. Assume that user 34 utilizes a print function within application 36 to print e-mail 156.

Upon initiating the print function, printer advertisement process 10 may receive 100 an indication that such a print function was initiated. Upon receiving 100 such an indication, printer advertisement process 10 may partition 102 printable area 150 into a plurality of printable areas. An example of such a plurality of printable areas includes (in this example) printable area 152 and printable area 154. A first area, chosen from the plurality of printable areas, may be configured to include at least a portion of the content to be printed. A second area, chosen from the plurality of printable areas, may be configured to include one or more advertisements. By partitioning 102 printable area 150 into e.g. printable areas 152, 154, printer advertisement process 10 may modify print job 38 into modified print job 42, which may be provided 104 to printing device 16 (via network 20 and/or network 22) for processing and printing.

As discussed above, one of the printable areas (e.g. printable area 154) into which printable area 150 is partitioned 102 may be configured to include one or more advertisements. An example of such an advertisement is the Lexmark™ advertisement 158 shown to populate printable area 154. Printer advertisement process 10 may obtain 106 e.g., advertisement 158 from a remote source. An example of such a remote source may include but is not limited to advertisement server computer 24. As discussed above, advertisement server computer 24 may execute advertisement distribution process 26 that distributes advertisements 28 to devices executing printer advertisement process 10, such as computing device 12.

When obtaining 106 advertisements from e.g. advertisement server computer 24, the advertisements may be obtained in a plurality of different ways. For example, computing device 12 may obtain 108 the advertisements (e.g. advertisement 158) prior to providing modified print job 42 to printing device 16. Accordingly, computing device 12 may provide e.g. advertisement 158 to printing device 16, which may be incorporated into modified print job 42. Therefore and continuing with the above-stated example, printer advertisement process 10 may partition 102 printable area 150 into e.g. printable areas 152, 154, wherein printable area 154 is configured to receive an advertisement. Printer advertisement process 10 may obtain from advertisement server computer 24 one or more advertisements (e.g. advertisement 158), which may be sized to fit within printable area 154. Upon obtaining such advertisements from advertisement server computer 24, printer advertisement process 10 may incorporate the obtained advertisements into modified print job 42, which may be provided to printing device 16.

Alternatively, modified print job 42 may be provided to printing device 16 without any advertisements. Accordingly and assuming that printing device 16 has access to advertisement server computer 24, upon receiving “advertisement-absent” modified print job 42, printing device 16 may obtain 110 the advertisements (e.g. advertisement 158) from advertisement server computer 24. Therefore and continuing with the above-stated example, printer advertisement process 10 may partition 102 printable area 150 into e.g. printable areas 152, 154, wherein printable area 154 is configured to receive an advertisement. Printer advertisement process 10 may provide modified print job 42 to printing device 16, wherein modified print job 42 does not include any advertisements for populating printable area 154. However, upon receiving modified print job 42, printing device 16 may obtain e.g. advertisement 158 from advertisement server computer 24. Advertisement 158 may then be inserted into modified print job 42 prior to being printed on printing device 16.

Prior to obtaining 106 advertisements stored on e.g. advertisement server computer 24, printer advertisement process 10 may perform 112 a data mining process on the content to be printed so that e.g. the advertisements obtained 106 may be directed towards the topic of the content to be printed. For example, if e-mail 156 concerns a trip to Walt Disney World in Orlando, Fla., printer advertisement process 10 may request from advertisement server computer 24 advertisements concerning e.g. Walt Disney World and/or Orlando, Fla. Therefore, the advertisements obtained 106 may be directed towards e.g. hotels within Orlando, Fla., things to do within Walt Disney World, and sites to see around Walt Disney World.

While printable area 154 is shown to be a rectangular area positioned proximate the bottom of the printable page, other configurations are possible and are considered to be within the scope of this disclosure. For example, the portion of the printable area into which advertisements may be inserted may be any essentially rectangular area positioned proximate one of the edges of the printable page that is producible on printing device 16. Additionally, the portion of the printable area into which the advertisements are inserted need not be limited to a rectangle area, as other general shapes are possible and are considered to be within the scope of this disclosure.

For example, printer advertisement process 10 may utilize a whitespace methodology to algorithmically determine free, unused space within the content to be printed. The result of a whitespace methodology may be a list of available areas into which advertisements may be inserted. Printer advertisement process 10 may then select one, multiple, or all of these available areas for advertisement insertion.

Further, printer advertisement process 10 may utilize an overlay methodology that may not be concerned with the position of content within the printed page and may simply render advertisements (at a defined level of transparency) across the entire printed page, similar to the manner in which a watermark is placed on a printed page.

As an additional example, printer advertisement process 10 may utilize a integrated space allocation methodology that interleaves advertisements within the content to be printed within the printed page. For example, an initial third of the content may be printed and an advertisement may be inserted, followed by the second third of the content, followed by another advertisement, and finally followed by the final third of the content.

A number of implementations have been described. Nevertheless, it will be understood that various modifications may be made. Accordingly, other implementations are within the scope of the following claims.

What is claimed is:

1. A method comprising:
receiving an indication, on a computing device, of content to be printed on a printing device; and
partitioning a portion of a printable area of the printing device into at least two printable areas, a first of the printable areas being configured for including at least a portion of the content and a second of the printable areas being configured for including one or more advertisements, thus defining a modified print job.

2. The method of claim 1 further comprising:
providing the modified print job to the printing device.

3. The method of claim 1 further comprising:
obtaining the one or more advertisements from a remote source.

4. The method of claim 3 wherein obtaining the one or more advertisements from a remote source includes:
obtaining, on the computing device, the one or more advertisements from the remote source.

5. The method of claim 3 wherein obtaining the one or more advertisements from a remote source includes:
obtaining, on the printing device, the one or more advertisements from the remote source.

6. The method of claim 3 wherein the remote source is a remote advertisement server.

7. The method of claim 1 wherein the second of the printable areas being configured for including one or more advertisements includes an essentially rectangular area positioned proximate one of the edges of a printable page producible by the printing device.

8. A computer program product residing on a computer readable medium having a plurality of instructions stored thereon which, when executed by a processor, cause the processor to perform operations comprising:
receiving an indication, on a computing device, of content to be printed on a printing device; and
partitioning a portion of a printable area of the printing device into at least two printable areas, a first of the printable areas being configured for including at least a portion of the content and a second of the printable areas being configured for including one or more advertisements, thus defining a modified print job.

9. The computer program product of claim 8 further comprising instructions for:
providing the modified print job to the printing device.

10. The computer program product of claim 8 further comprising instructions for:
obtaining the one or more advertisements from a remote source.

11. The computer program product of claim 10 wherein the instructions for obtaining the one or more advertisements from a remote source include instructions for:
obtaining, on the computing device, the one or more advertisements from the remote source.

12. The computer program product of claim 10 wherein the instructions for obtaining the one or more advertisements from a remote source include instructions for:
obtaining, on the printing device, the one or more advertisements from the remote source.

13. The computer program product of claim 10 wherein the remote source is a remote advertisement server.

14. The computer program product of claim 8 wherein the second of the printable areas includes an essentially rectangular area positioned proximate one of the edges of a printable page producible by the printing device.

15. A print driver configured to perform operations comprising:
receiving an indication, on a computing device, of content to be printed on a printing device; and
partitioning a portion of a printable area of the printing device into at least two printable areas, a first of the printable areas being configured for including at least a portion of the content and a second of the printable areas being configured for including one or more advertisements, thus defining a modified print job.

16. The print driver of claim 15, wherein the print driver is further configured to perform operations comprising:
providing the modified print job to the printing device.

17. The print driver of claim 15, wherein the print driver is further configured to perform operations comprising:
obtaining the one or more advertisements from a remote source.

18. The print driver of claim 17 wherein obtaining the one or more advertisements from a remote source includes:
obtaining, on the computing device, the one or more advertisements from the remote source.

19. The print driver of claim 17 wherein obtaining the one or more advertisements from a remote source includes:
obtaining, on the printing device, the one or more advertisements from the remote source.

20 The print driver of claim 17 wherein the remote source is a remote advertisement server.
